(19) United States
(12) Patent Application Publication
(10) Pub. No.: US 2008/0303944 A1
(43) Pub. Date: Dec. 11, 2008

(54) Television receiver

(75) Inventor: Hiroaki Shibahara, Osaka (JP)

Correspondence Address: Yokoi & Co., U.S.A., Inc., 13700 Marina Pointe Drive #723, Marina Del Rey, CA, 90292, US

(73) Assignee: Funai Electric Co., Ltd., Osaka (JP)

(21) Appl. No.: 12/156,383

(22) Filed: May 31, 2008

(30) Foreign Application Priority Data
Jun. 11, 2007 (JP) JP2007-153782

(51) Int. Cl. H04N 7/00

(52) U.S. Cl. 348/468; 348/E07.001

(57) ABSTRACT

A television receiver 100 receives, with a tuner 11, a television broadcast signal to which text data indicating emergency information is added, and displays an image on the basis of the received television broadcast signal. In the television receiver 100, a TS decoder 12 separates the text data from the received television broadcast signal, and temporarily stores the text data into a service information processor 15. Then, the separated text data is multiplexed with image data by a multiplexing processor 16 and outputted to a display module 30. In accordance with a text data display switching program 302, when channels are switched, a controller 21 issues an instruction to the multiplexing processor 16 not to display alarm text in image data that is displayed after the channels are switched.

### CROSS-REFERENCES TO RELATED APPLICATIONS

The present application is related to the Japanese Patent Application No. 2007-153782, filed Jun. 11, 2007, the entire disclosure of which is expressly incorporated by reference herein.

### BACKGROUND OF THE INVENTION

1. Field of the Invention

The present invention relates to a television receiver that receives a television broadcast signal to which text data is added, in particular, a television receiver that multiplexes the above-mentioned text data with image data for display.

2. Description of the Related Art

Techniques for multiplexing text data with image data for display are known in the related art. Text data refers to data mainly including character information or the like. By multiplexing text data with image data, character information is displayed in a part of an image, thus allowing information to be presented to the viewers in characters. A known application of such a technique is the EAS (Emergency Alert System) that complies with the Emergency Alert Format based on ANSI (American National Standards Institute) J-STD042.

Text data is received by a television receiver while being multiplexed into a transport stream constituting a television broadcast signal. The received text data is separated from image data within the television receiver and then multiplexed with image data before being displayed on a screen. When such text data is displayed on the screen, the displayed text data may interfere with the viewing of an image. That is, since text data is displayed in a part of the screen with no relevance to the image bring broadcast, the text data may interfere with the viewing of an image as a part of the image is hidden under the text data, for example.

In view of this, JP2002-374219A discloses a technique in which multiplexed text data is erased by an erase command outputted by depressing an operation key.

According to this technique, text can be erased from the screen at any time by issuing an erase command.

JP2006-183963A discloses a technique in which, instead of displaying received text data on the screen, only an indication to the effect that text data has been received is displayed on the screen, and the text data is recorded.

According to this technique, the recorded text data can be displayed at once later, thus making it possible to prevent the text data from interfering with the viewing experience.

The above-described inventions have the following problems. That is, it is necessary to output an erase command to erase text data. Normally, when text data is displayed on the screen, it is frequently the case that the user tries to erase the text data by switching channels, and it is too much trouble for the user to issue an erase command.

Further, when the broadcast station broadcasting on the channel that is switched to is not transmitting text data, unless an erase command is outputted, text data transmitted by the broadcast station broadcasting on the last channel tuned to before switching channels will be displayed as it is. Thus, depending on the case, display of meaningless text data is continued.

### BRIEF SUMMARY OF THE INVENTION

The present invention discloses a television receiver that makes it possible to erase text data displayed on the screen by switching of channels.

The present invention discloses a television receiver that receives a television broadcast signal to which text data indicating emergency information is added, and displays an image on a basis of the received television broadcast signal, comprising: a text data separating section that separates the text data from the received television broadcast signal; a multiplexing section that multiplexes the separated text data from an image data displayed on a screen; and a text data switching section that issues, when channels are switched, an instruction to the multiplexing section not to display the text data on the screen.

According to an embodiment of the present invention configured as mentioned above, the text data separating section separate text data from the received television broadcast signal, and the multiplexing section multiplexes the text data with image data. Further, when channels are switched, the text data display switching section issues an instruction to the multiplexing section not to display the text data on image data that is displayed after the channels are switched.

Accordingly, text data displayed on the screen is erased every time channels are switched. Text data displayed on the screen can be thus made non-displayed by switching of channels.

An optional aspect of the present invention provides the text data indicating emergency information, various kinds of such text data exist. Preferably, the text data is alarm text that is displayed on the basis of Emergency-Alert System (EAS) information.

According to an embodiment of the present invention as mentioned above, alarm text displayed on the basis of EAS information is displayed, and when channels are switched, the text data is made non-displayed.

Further, as a specific configuration of the text data display switching section, preferably, the text data display switching section is a microcomputer that executes processing on the basis of a program stored in a non-volatile storage medium. That is, by controlling the display of text data by a microcomputer that executes processing on the basis of a program, the function of the present invention can be realized more easily.

Further, as a specific configuration of the present invention, the text data is alarm text that is displayed on the basis of Emergency-Alert System (EAS) information;

the television receiver further comprises a microcomputer that executes predetermined computation; the text data separating section, the multiplexing section, and the text data display switching section are programs that provide the microcomputer with their respective functions; the method of displaying the EAS information is that of forcibly switching channels or that of displaying alarm text on a screen: and if the method of displaying the EAS information is the information that displays alarm text on a screen, and the microcomputer receives the a control signal indicating that channels have been switched, the text data display switching section commands the multiplexing section to multiplex the separated text data with image data displayed on a screen.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments. Referring to the drawings in which like reference character(s) present corresponding parts throughout:

FIG. 1 is a block diagram of a television receiver according to an embodiment of the present invention;

FIG. 2 is a flowchart illustrating an EAS information display program;

FIG. 3 is a flowchart showing a text data display switching program; and

FIGS. 4A and 4B are views showing an example of an image in which alarm text is multiplexed, as displayed on a screen.

### DETAILED DESCRIPTION OF THE INVENTION

Embodiments of the present invention will be described below in the following order of topics.

### (1) Configuration of Television Receiver

### (2) Operation/effect of Television Receiver

### (3) Conclusion

### (1) CONFIGURATION OF TELEVISION RECEIVER

A television receiver 100 according to an embodiment of the present invention receives, with a tuner, a television broadcast signal to which text data indicating emergency information is added, and displays an image on the basis of the received television broadcast signal. In the television receiver, a TS decoder (text data separating section) separates the text data from the received television broadcast signal, and temporarily stores the text data into a service information processor. Then, the separated text data is multiplexed with image data by a multiplexing processor (multiplexing section) and outputted to a display module. Further, in the television receiver according to an embodiment of the present invention, when channels are switched, in accordance with a text data display switching program, a controller issues an instruction to the multiplexing processor not to display text data in image data that is displayed after the channels are switched. Thus, even when text data is displayed on the screen, the user can make the text data non-displayed by switching channels.

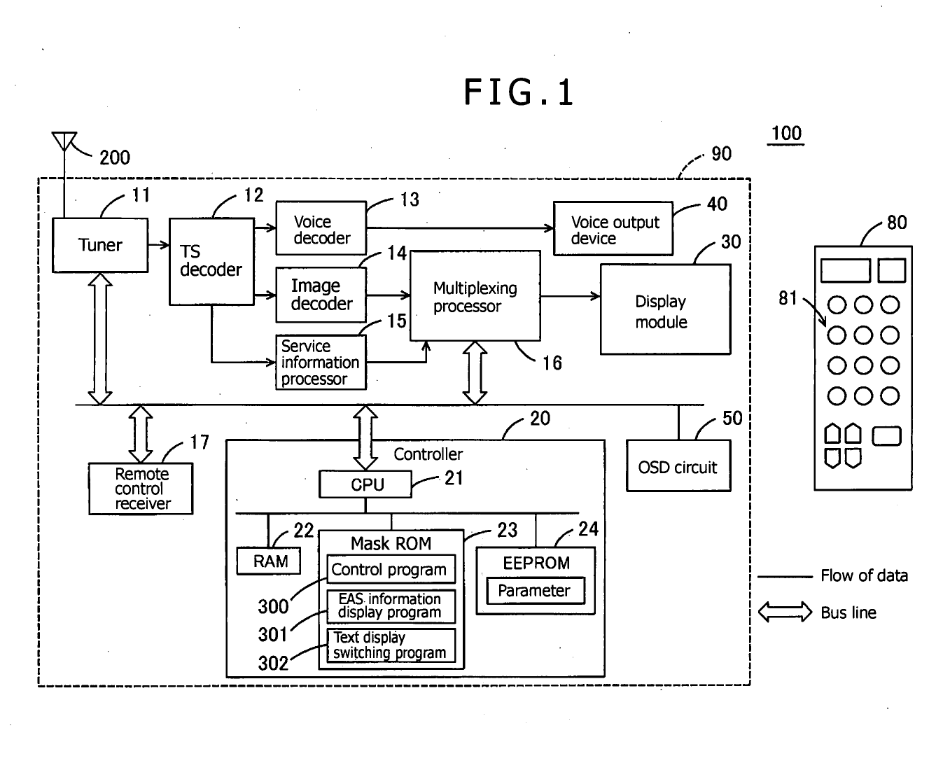

As shown in FIG. 1, the television receiver 100 according to an embodiment of the present invention includes an image receiver 90, and a remote control 80. The image receiver 90 includes a tuner 11 that applies demodulation processing, error correction processing, and the like to a digital television broadcast signal (hereinafter, referred to as DTV signal) received from an antenna 200 or a cable, a transport stream decoder 12 that acquires image data, voice data, and additional information from the demodulated DTV signal, a voice decoder 13 that applies signal processing to the acquired voice data, an image decoder 14 that applies signal processing to the acquired image data, a service information processor 15 that applies predetermined processing to the acquired additional information, a multiplexing processor 16 that multiplexes the additional information and the image data together, a controller 20 that controls the drive of the television receiver 100, a display module 30 for displaying an image, a voice output device 40 for outputting voice, a remote control receiver 17 that receives a control signal from the remote control 80, and an OSD circuit 50 for displaying an OSD (On screen display) image.

The television receiver according to an embodiment of the present invention receives a DTV signal, and displays an image in which text data is multiplexed. When the remote control 80 is operated for tuning, the controller 20 causes the tuner 11 to demodulate a DTV signal corresponding to the channel being tuned in, from a DTV signal received by the antenna 200, followed by error correction. The DTV signal demodulated by the tuner 11 constitutes a transport stream with packets having various kinds of data. The demodulated DTV signal is supplied to the transport stream decoder (hereinafter, referred to as TS decoder) 12. The TS decoder 12 extracts packet-by-packet data of a target program from the transport stream, and separates the data into image packets, voice packets, and information data having information related to the broadcast being received, before outputting these pieces of data. The image packets, the voice packets, and the information data are supplied to the image decoder 14, the voice decoder 13, and the service information processor 15 that will be described later, respectively.

The image decoder 14 extracts from the supplied image packets encoded image data that has been compression-encoded on the basis of the MPEG (Motion Pictures Expert Group)-2 scheme or the like. Further, the image decoder 14 applies decompression processing or the like to the extracted encoded image data to restore image data. The voice decoder 13 subjects the supplied voice packets to decode processing, thereby restoring voice data.

The service information processor 15 acquires information data, and extracts various kinds of information from the acquired information data. The information data includes programs and information related to their reception, and the television receiver 100 performs reception of programs, provision of service information of programs, and the like by using these pieces of information. The service information includes subtitle information as related information related to channel numbers, broadcast start times, end times, genres, titles, and image data of individual programs, parental information for setting viewing restrictions, and the like, and also EAS (Emergent-Alert System) information.

It should be noted that the EAS refers to a service that transmits emergency information such as tornado warnings by multiplexing the emergency information into a television broadcast signal. The service information processor 15 extracts service information data from information data separated by the TS decoder 12, and stores the service information data into a memory (not shown) or the like for management.

The multiplexing processor 16 multiplexes alarm text in the horizontal period of an image signal supplied from the image decoder 14. The alarm text refers to a text file recording character information contained in the EAS information. The multiplexing processor 16 multiplexes the alarm text with image data in accordance with a program recorded in the controller 20 described later. Thereafter, the multiplexing processor 16 outputs an image signal in which the alarm text is multiplexed, to the display module 30. The display module 30 performs digital/analog conversion on the image data to generate a drive voltage, thus driving the screen. In this way, the television receiver 100 displays an image on the basis of an image signal in which the alarm text is multiplexed.

The controller 20 controls whether or not the alarm text is to be displayed by the multiplexing processor 16, in addition to controlling the drive of the television receiver 100. The controller 20 includes a CPU (Central Processing Unit) 21 as the computing center, a mask ROM (Read Only Memory) 23 in which various programs are stored, an EEPROM (Erasable and Programmable ROM) 24 in which rewritable database is stored, and a RAM (Random Access Memory) 22 into which the CPU 21 expends database or programs.

The mask ROM 23 stores a control program 300 used for the CPU 21 to control the drive of the television receiver 100, an EAS information display program 301 for displaying alarm text, and a text display switching program 302 for performing a control as to whether or not to multiplex alarm text with image data inputted to the multiplexing processor 16. The EEPROM 24 stores various parameters 400 that are referred to when processing is executed.

The EAS information display program 301 is a program for multiplexing alarm text with image data inputted to the multiplexing processor 16. When EAS information is separated from a DTV signal and inputted to the service information processor 15, the CPU 21 reads the EAS information display program 301 stored in the mask ROM 23 and expands the read EAS information display program 301 into the RAM 22. The CPU 21 multiplexes alarm text with the image data in accordance with the expended EAS information display program 301.

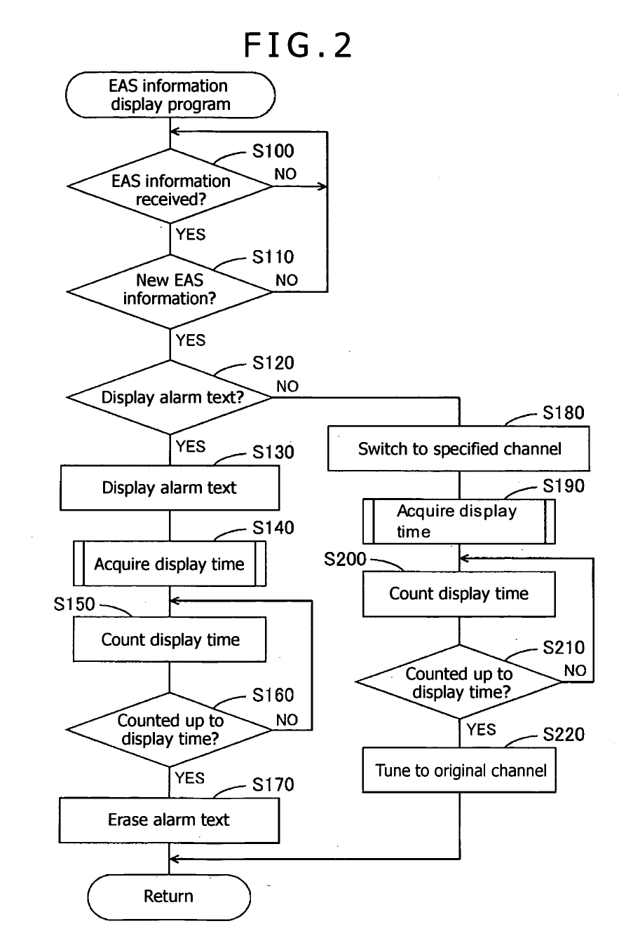

FIG. 2 is a flowchart illustrating the EAS information display program 301. First, the CPU 21 determines whether or not EAS information has been inputted to the service information processor 15 (step S100). If EAS information has been inputted, the CPU 21 determines whether or not the inputted EAS information is new information (step S110). If it is determined by the CPU 21 that the inputted EAS information is new, it is determined whether or not the method of displaying the EAS information is that of forcibly switching channels or that of displaying alarm text (step S120). If the EAS information is to be displayed by forcibly switching channels, the CPU 21 instructs the tuner 11 to switch to a specified channel (step S180), and display the channel that is switched to, for several seconds thereafter (steps S190 to S220). If the method of displaying the EAS information is that of displaying alarm text, the CPU 21 causes alarm text information stored in the service information processor 15 to be outputted to the multiplexing processor 16 (step S130). Alarm text is thus multiplexed with the image data. Then, the CPU 21 reads from the EEPROM the time for which the alarm text is to be displayed (step S140). Further, the CPU 21 performs counting up to the acquired display time (step S150). Then, upon finishing counting up to the acquired display time (step S160), the CPU 21 issues an instruction to the service information processor 15 not to output the alarm text information to the multiplexing processor 16 (step S170). As a result of the above-mentioned series of processing, image in which the alarm text is multiplexed is displayed on the screen. The text display switching program 302 provides the CPU 21 with the function of instructing the multiplexing processor 16 not to multiplex alarm text with image data when channels are switched. When channels are switched by operating channel keys 81 of a remote control 80, a channel switch signal is outputted from the remote control receiver 17 to the CPU 21. If the above-mentioned EAS information display program 301 is being executed at this time, the text display switching program 302 stored in the mask ROM 22 is read, and the text display switching program 302 is executed by interruption.

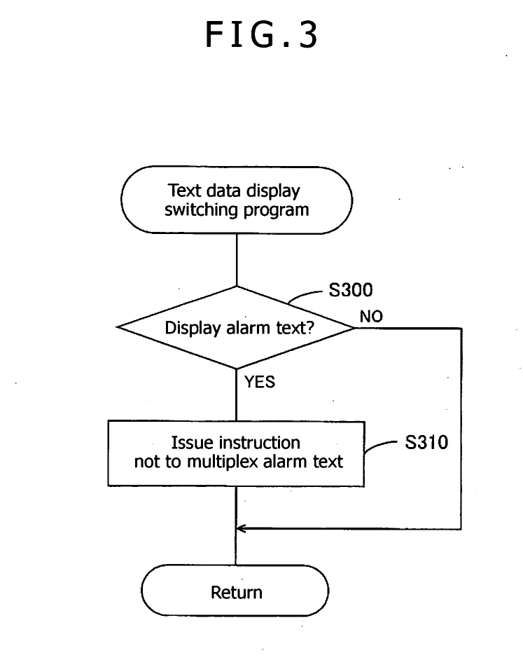

FIG. 3 is a flowchart of the text display switching program 302. First, the CPU 21 determines whether or not the method of displaying EAS information is that of forcibly switching channels or that of displaying alarm text (step S300). If the display method is that of displaying alarm text, the CPU 21 issues an instruction to the service information processor 15 not to output the alarm text to the multiplexing processor 16 (step S310). Then, the CPU 21 cancels the interruption, and returns to the EAS information display program 301. Through the series of processing described above, when channels are switched, the CPU 21 makes the alarm text non-displayed.

### (2) OPERATION/EFFECT OF TELEVISION RECEIVER

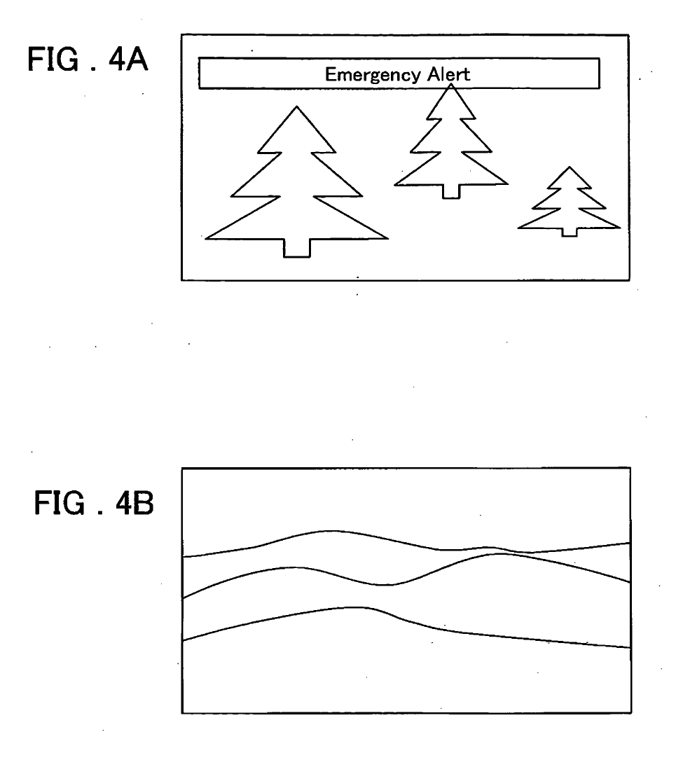

Herein below, the operation and effect of the television receiver 100 according to an embodiment of the present invention will be described with reference to FIGS. 4A and 4B. Assume a case where, in a state with the television receiver 100 displaying an image, the tuner 11 has received a DTV signal in which EAS information is multiplexed. At this time, as shown in FIG. 4A, alarm text is displayed in an upper part of the screen. In this case, character information “Emergency Alert” is displayed by the alarm text. When channels are switched by operating the channel keys of the remote control 80 in this state, as shown in FIG. 4B, the alarm text that has been displayed in an upper part of the screen ceases to be displayed. That is, by switching channels, the alarm text is made non-displayed on the next screen. This saves the user the trouble of issuing an erase command with the remote control 80 or the like. Further, if the broadcast station broadcasting the channel that is switched to is not transmitting text data, the alarm text transmitted by the last broadcast station tuned to before changing channels is not displayed as it is, thus making it possible to prevent display of meaningless alarm text from being continued.

### (3) CONCLUSION

The television receiver 100 according to an embodiment of the present invention receives, with the tuner, a television broadcast signal to which text data indicating emergency information is added, and displays an image on the basis of the received television broadcast signal. In the television receiver 100, the TS decoder separates the text data from the received television broadcast signal, and temporarily stores the text data into the service information processor. Then, the separated text data is multiplexed with image data by the multiplexing processor and outputted to the display module 30. Further, in the television receiver, in accordance with the text data display switching program, when channels are switched, the controller 20 issues an instruction to the multiplexing processor 16 not to display alarm text in image data that is displayed after the channels are switched. Thus, even when text data is displayed on the screen, alarm text can be made non-displayed by switching channels.

Incidentally, it is needless to say that the present invention is not limited to the embodiment described above. Although it is obvious to persons skilled in the art,
the application of the mutually interchangeable members, configurations, and the like disclosed in the above embodiment by changing their combination as required,
the application of the members, configurations, and the like, which are not disclosed in the above embodiment but are publicly known art and mutually interchangeable with the members, configurations, and the like disclosed in the above embodiment, by interchanging them or by changing their combination as required, and
the application of the members, configurations, and the like, which are not disclosed in the above embodiment but which any person skilled in the art may be able to envisage as substitutes for the members, configurations, and the like disclosed in the above embodiment on the basis of the publicly known art and the like, by interchanging them or by changing their combination as required,
   are each disclosed as an embodiment of the present invention.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A television receiver that receives a television broadcast signal to which text data indicating emergency information is added, and displays an image on a basis of the received television broadcast signal, comprising:
a text data separating section that separates the text data from the received television broadcast signal;
a multiplexing section that multiplexes the separated text data from an image data displayed on a screen; and
a text data switching section that issues, when channels are switched, an instruction to the multiplexing section not to display the text data on the screen.

2. The television receiver according to claim 1, wherein the text data is alarm text that is displayed on the basis of Emergency-Alert System (EAS) information.

3. The television receiver according to claim 1, wherein:
the method of displaying the EAS information is that of forcibly switching channels or that of displaying alarm text on a screen: and
If the method of displaying the EAS information is the information that displays alarm text on a screen, the multiplexing section multiplexes the separated text data with image data displayed on a screen.

4. The television receiver according to claims 1, further comprising a microcomputer that executes predetermined computation,
wherein the text data separating section, the multiplexing section, and the text data display switching section are programs that provide the microcomputer with their respective functions.

5. The television receiver according to claim 1, wherein:
the text data is alarm text that is displayed on the basis of Emergency-Alert System (EAS) information;
the television receiver further comprises a microcomputer that executes predetermined computation;
the text data separating section, the multiplexing section, and the text data display switching section are programs that provide the microcomputer with their respective functions;
the method of displaying the EAS information is that of forcibly switching channels or that of displaying alarm text on a screen: and
if the method of displaying the EAS information is the information that displays alarm text on a screen, and the microcomputer receives the a control signal indicating that channels have been switched,
the text data display switching section commands the multiplexing section to multiplex the separated text data with image data displayed on a screen.
